(19) United States
(12) Patent Application Publication
(10) Pub. No.: US 2025/0269829 A1
(43) Pub. Date: Aug. 28, 2025

(54) VEHICLE CONTROL APPARATUS AND VEHICLE CONTROL METHOD

(71) Applicant: TOYOTA JIDOSHA KABUSHIKI KAISHA, Toyota-shi (JP)

(72) Inventor: Takahiro KUNO, Toyota-shi (JP)

(73) Assignee: TOYOTA JIDOSHA KABUSHIKI KAISHA, Toyota-shi (JP)

(21) Appl. No.: 19/058,332

(22) Filed: Feb. 20, 2025

(30) Foreign Application Priority Data
Feb. 26, 2024 (JP) 2024-026352

(51) Int. Cl. B60T 7/22

(52) U.S. Cl. CPC B60T 7/22; B60T 2220/03; B60T 2250/04

(57) ABSTRACT

A vehicle control apparatus is configured to: obtain, based on a predetermined lateral acceleration for a trajectory calculation, a steering start time threshold which is a time which it takes for a host vehicle to collide with an object at a time point at which a driver of the host vehicle has to start steering the host vehicle in order to avoid a collision between the host vehicle and the object; and start an automatic braking, when an obtained predicted time to collision becomes shorter than or equal to either one of the steering start time threshold and an automatic braking start time threshold, whichever is shorter. The automatic braking start time threshold is a time which it takes for the host vehicle to collide with the object at a time point at which the automatic braking has to be started in order to avoid the collision between the host vehicle and the object.

### TECHNICAL FIELD

The present disclosure relates to a vehicle control apparatus and a vehicle control method for executing a collision damage mitigation control using an automatic braking.

### BACKGROUND

One of conventional apparatuses (hereinafter, referred to as a conventional apparatus) for executing a collision damage mitigation control obtains “a steering limit time to collision TTCc at which a driver can avoid a collision by starting steering” based on a lateral position (e.g., a lap rate) of an object with respect to a host vehicle, when it determines that the host vehicle is likely to collide with the object.

In a case where the steering limit time to collision TTCc is greater than a brake limit time to collision TTCy, the conventional apparatus applies a strong brake force to the host vehicle when a time to collision TTC becomes equal to or shorter than the brake limit time to collision TTCy. Whereas, in a case where the steering limit time to collision TTCc is shorter than the brake limit time to collision TTCy, the conventional apparatus applies the strong brake force to the host vehicle when the time to collision TTC becomes equal to or shorter than the steering limit time to collision TTCc (refer to Japanese Patent Application Laid-Open No. 2017-114427).

### SUMMARY

In the case where the automatic braking is activated when the time to collision is equal to the steering limit time to collision TTCc, unnecessary activation of the automatic braking can be avoided when the driver is trying to avoid the collision by steering. However, if the steering is not actually operated or if an actual steering amount is not sufficient for a steering amount necessary to avoid the collision, the host vehicle actually collides with the object and the host vehicle is not sufficiently decelerated before the collision. Namely, in this case, a deceleration amount by the automatic braking is insufficient.

The present disclosure is made to cope with this problem. That is, one of objects of the present disclosure is to provide a vehicle control apparatus and a vehicle control method which can avoid the unnecessary activation of the automatic braking as much as possible, and which can reduce a frequency of the case where the deceleration amount by the automatic braking is insufficient.

One of embodiments of the present disclosure comprises a controller (10) configured to:
obtain information on an object present around a host vehicle;
obtain, based on the information, a predicted time to collision (TTC) which it takes for the host vehicle to collide with the object (S515);
obtain, based on a predetermined lateral acceleration for a trajectory calculation, a steering start time threshold (TSRSth, TSLSth) which is a time which it takes for the host vehicle to collide with the object at a time point at which a driver of the host vehicle has to start steering the host vehicle in order to avoid a collision between the host vehicle and the object (S530, S540); and
start an automatic braking (S565), when the obtained predicted time (TTC) to collision becomes equal to or shorter than either one of the steering start time threshold (TSRSth, TSLSth) and an automatic braking start time threshold (TBSth), whichever shorter, the automatic braking start time threshold being a time which it takes for the host vehicle to collide with the object at a time point at which the automatic braking has to be started in order to avoid the collision between the host vehicle and the object (refer to S550 to S560).

The present inventor has studied various data and found that “a steering amount or a steering rate (speed)” by the driver for avoiding the collision tends to be small when the host vehicle speed is relatively high, as compared to a case where the host vehicle speed is relatively low.

In view of the above, the controller according to the above-described embodiment is configured to obtain the steering start time threshold using, as the lateral acceleration for a trajectory calculation, a value which is smaller when the speed of the host vehicle is higher than a predetermined speed as compared to when the speed of the host vehicle is lower than the predetermined speed (refer to FIGS. 2A and 2B).

According to this embodiment, the lateral acceleration for a trajectory calculation is relatively small when the speed of the host vehicle (i.e., the host vehicle speed) is high, and thus, the obtained steering start time threshold becomes relatively long when the speed of the host vehicle is high. Therefore, a range of the host vehicle speed in which the automatic braking start time threshold is shorter than the steering start time threshold expands to a higher speed. Consequently, the automatic braking is started at the automatic braking start time threshold in a rage of the host vehicle speed which includes a higher speed region as compared to a range of the host vehicle speed in which the automatic braking is started at the automatic braking start time threshold in the conventional apparatus. Accordingly, the vehicle control apparatus according to the above-described embodiment can shrink/reduce a speed range in which the deceleration amount due to the automatic braking is insufficient while avoiding the unnecessary automatic braking as much as possible, so as to reduce a frequency that the deceleration amount due to the automatic braking is insufficient.

Notably, in the above description, in order to facilitate understanding of the present disclosure, the constituent elements corresponding to those of an embodiment which will be described later are accompanied by parenthesized symbols and/or names which are used in the embodiment; however, the constituent elements of the disclosure are not limited to those in the embodiment defined by the symbols and/or names. The present disclosure also covers a vehicle control method and a program thereof.

### BRIEF DESCRIPTION OF THE DRAWINGS

FIG. 1 is a schematic diagram of a vehicle control apparatus according to an embodiment of the present disclosure.

FIG. 2A is a figure for describing a steering start time threshold.

FIG. 2B is a figure for describing the steering start time threshold.

FIG. 3 is a graph showing a relationship between a relative speed of a stationary object and a deceleration amount due to an automatic braking.

FIG. 4A shows a look-up table defining a relationship between the host vehicle speed and the lateral acceleration for a trajectory calculation.

FIG. 4B shows a look-up table defining another relationship between the host vehicle speed and the lateral acceleration for a trajectory calculation.

FIG. 4C shows a look-up table defining yet another relationship between the host vehicle speed and the lateral acceleration for a trajectory calculation.

FIG. 5 shows a routine executed by a CPU of a vehicle control ECU shown in FIG. 1.

FIG. 6 shows a routine executed by a CPU of a modified example of the vehicle control ECU.

### DETAILED DESCRIPTION

### (Configuration)

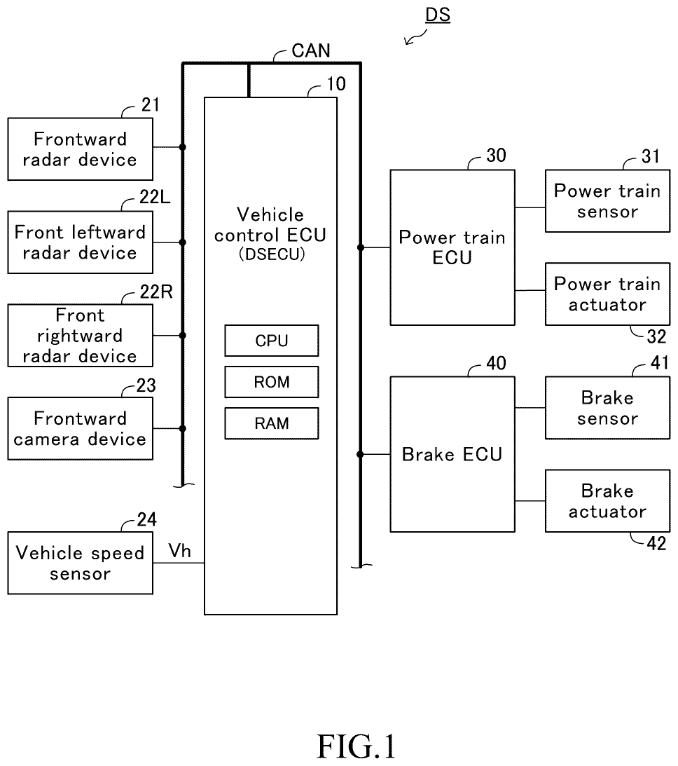

A vehicle control apparatus (hereinafter, referred to as the present control apparatus”) DS, shown in FIG. 1, according to an embodiment of the present disclosure is mounted on a host vehicle. The host vehicle may be a vehicle having an internal combustion engine as a drive source, a vehicle having an electric motor as the drive source (namely, an electric vehicle), or a hybrid vehicle.

The present control apparatus DS comprises a vehicle control ECU 10, a power train ECU 30, and a brake ECU 40. These ECUs are connected to each other through Controller Area Network (CAN) in such a manner that they can exchange data with each other. An “ECU” is an abbreviation of an electronic control unit, and is referred to as a controller or a computer. The ECU is an electronic control circuit including a microcomputer as a main component. The microcomputer comprises a CPU (i.e., processor), a ROM, a RAM, and an interface. The CPU realizes various functions by executing instructions (routines) stored in the memory (i.e., the ROM).

The present control apparatus DS comprises a frontward radar device 21, a front leftward radar device 22L, a front rightward radar device 22R, and a frontward camera device 23. These devices can exchange data with the vehicle control ECU 10. Furthermore, the vehicle control ECU 10 is connected with a vehicle speed sensor 24 which detects a speed of the host vehicle (i.e., host vehicle speed Vh) so as to receive the output signal of the vehicle speed sensor 24.

Each of the frontward radar device 21 the front leftward radar device 22L, and the front rightward radar device 22R is simply referred to as a “radar device”, when they do not have to be discriminated from each other.

The radar device is a well-known device configured to obtain information on an object that is present around the host vehicle, using electrical waves in a millimeter waveband, and includes an unillustrated radar transmission-reception section and an unillustrated processing section (i.e., a radar ECU). The transmission-reception section transmits, every time a predetermined time elapses, electrical waves into a predetermined detection area and receives electrical waves reflected at an object. The transmission-reception section transmits information on the transmitted electrical waves and on the received electrical waves to the processing section. The processing section obtains radar information based on the information sent from the transmission-reception section, and transmits the radar information to the vehicle control ECU 10. The radar information includes a distance between the object and a position at which the transmission-reception section is provided, an azimuth of the object with respect to the transmission-reception section, and a relative speed of the object with respect to the transmission-reception section.

The frontward radar device 21 is disposed at a center in a vehicle width direction of a front end of the host vehicle. The frontward radar device 21 obtains the radar information on an object which is present in front of the host vehicle, and transmits the radar information to the vehicle control ECU 10.

The front leftward radar device 22L is disposed at a left end in the vehicle width direction of the front end of the host vehicle. The front leftward radar device 22L obtains the radar information on an object which is present front leftward of the host vehicle, and transmits the radar information to the vehicle control ECU 10.

The front rightward radar device 22R is disposed at a right end in the vehicle width direction of the front end of the host vehicle. The front rightward radar device 22R obtains the radar information on an object which is present front rightward of the host vehicle, and transmits the radar information to the vehicle control ECU 10.

The vehicle control ECU 10 fuses the radar object information from these radar devices to produce radar fusion object information on the object present around the host vehicle. Note that object information is represented using a X-Y coordinate system. An X-axis of the X-Y coordinate system is an axis extending a front-rear axis direction of the host vehicle and passing through a center in the vehicle width direction of the vehicle. A Y-axis of the X-Y coordinate system is an axis orthogonal to the X-axis. An origin of the X-Y coordinate system is at the center in the vehicle width direction of the front end of the host vehicle. The radar fusion object information includes a distance (X-coordinate) between the host vehicle and the object, the azimuth of the object with respect to the host vehicle, and the relative speed of the object. In the present example, the relative speed is positive when the object comes closer to the host vehicle.

The frontward camera 23 includes an unillustrated camera and an unillustrated image ECU. The camera obtains image data by taking a picture of a scene in front of the host vehicle every time a predetermined time elapses. The image ECU recognizes (detects), based on the image data, “a left demarcation line and a right demarcation line” of a host lane, “a left demarcation line and a right demarcation line” of a left adjacent lane adjacent in the left side to the host lane, and “a left demarcation line and a right demarcation line” of a right adjacent lane adjacent in the right side to the host lane. The right demarcation line of the left adjacent line is the left demarcation line of the host lane. The left demarcation line of the right adjacent line is the right demarcation line of the host lane. A demarcation line of a lane is typically a lane demarcation line (i.e., a lane marker), and for example, is a white or yellow line. The image ECU obtains “a position and a direction” of the host vehicle with respect to a detected demarcation line, as a demarcation line information. In addition, the image ECU produces, based on the image data from the camera, camera information. The camera information includes “a position (a longitude position and a lateral position” of an object which is present in front of the host vehicle. The image ECU transmits the demarcation information and the camera information to the vehicle control ECU 10.

The vehicle control ECU 10 fuses the radar fusion object information and the camera object information to produce fusion object information which is final object information on the object which is present around the host vehicle.

A power train ECU 30 receives detection signals from power train sensor 31 including an acceleration pedal operation amount sensor. The power train ECU 30 drives power train actuator 32 to thereby control an unillustrated drive device including a drive source (e.g., an internal combustion engine and/or an electric motor) of the host vehicle, so as to adjust a driving force of the host vehicle.

A brake ECU 40 receives detection signals from brake sensor 41 including a brake pedal operation amount sensor. The brake ECU 40 drives a brake actuator 41 to thereby control an unillustrated brake device of the host vehicle, so as to adjust a brake force applied to the host vehicle.

### (Outline of Operation)

In the present specification, a time (a time length) which it takes for the host vehicle HV to collide with an object PV when the host vehicle HV maintains its current vehicle speed and its current moving direction is referred to as “a predicted time to collision TTC or a time to collision TTC”.

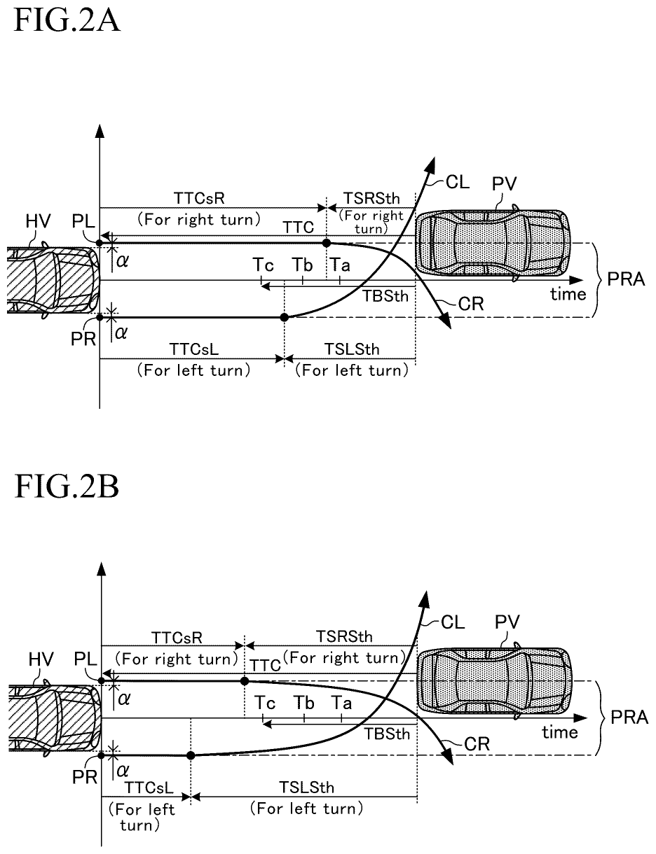

As shown in FIG. 2A, when the object (in this example, the preceding vehicle) PV is present in a predicted moving region PRA of the host vehicle HV (of) within a predetermined time from the current time point, the present control apparatus DS determines that the host vehicle is likely to collide with the object PV (i.e., there is a probability that the host vehicle collides with the object PV). The object PV with which the host vehicle is likely to collide is also referred to as an “obstacle”.

When the present apparatus DS determines that the host vehicle is likely to collide with the object PV, the apparatus DS obtains/calculates a time (a time length) which is referred to as a “steering start time threshold” from a “steering start limit time point” to a “time point at which the host vehicle HV reaches the object PV in a case where the host vehicle HV is not steered”. The steering start limit time point is a time point at which the driver of the host vehicle HV has to start to steer the host vehicle in order to avoid the collision. Namely, the “steering start time threshold” is equal to the “predicted time to collision TTC at the steering start limit time point”. The steering start time threshold includes a “steering start time threshold TSRSth for a right turn” and a “steering start time threshold TSLSth for a left turn”.

Specifically, the present control apparatus DS obtains, based on a “predetermined lateral acceleration for a trajectory calculation” which is a conceivable lateral acceleration of the host vehicle HV when the driver steers the host vehicle HV rightward, a trajectory CR of a “left end point PL which is a point obtained by shifting a front left end of the host vehicle HV by a marginal distance a leftward”, of when the host vehicle HV is presumed to steered rightward. This trajectory CR is (depicts) substantially a quadratic curve. Then, the present control apparatus DS parallelly shifts the trajectory CR in such a manner that a start point of the parallelly shifted trajectory CR is positioned on a line obtained by moving a “left end point PL” in the current moving direction of the host vehicle HV″ and the parallelly shifted trajectory CR passes through a point which is a predetermined distance away from the object PV. Thereafter, the present control apparatus DS acquires, as the “steering start time threshold TSRSth for a right turn”, a value obtained by dividing a distance between “the start point of the thus parallelly shifted trajectory CR” and “the object PV” by a relative speed of the object PV with respect to the host vehicle HV.

Similarly, the present control apparatus DS acquires the “steering start time threshold TSLSth for a left turn”. Namely, the present control apparatus DS obtains, based on a “predetermined lateral acceleration for a trajectory calculation” which is a conceivable lateral acceleration of the host vehicle HV when the driver steers the host vehicle HV leftward, a trajectory CL of a “right end point PR which is a point obtained by shifting a front left end of the host vehicle HV by a marginal distance a rightward”, of when the host vehicle HV is presumed to steered leftward. This trajectory CL is (depicts) substantially a quadratic curve. Then, the present control apparatus DS parallelly shifts the trajectory CL in such a manner that a start point of the parallelly shifted trajectory CL is positioned on a line obtained by moving a “right end point PR” in the current moving direction of the host vehicle HV″ and the parallelly shifted trajectory CL passes through a point which is the predetermined distance away from the object PV. Thereafter, the present control apparatus DS acquires, as the “steering start time threshold TSLSth for a left turn”, a value obtained by dividing a distance between “the start point of the thus parallelly shifted trajectory CL” and “the object PV” by the relative speed of the object PV with respect to the host vehicle HV.

When the predicted time to collision TTC becomes equal to or shorter than an automatic braking start time threshold TBSth, the present control apparatus DS starts an automatic braking if the predicted time to collision TTC is shorter than the steering start time threshold TSRSth for a right turn and is shorter than the steering start time threshold TSLSth for a left turn (refer to a case shown in FIG. 2A, where TBSth=Ta). This enables the host vehicle to fully stop before the host vehicle HV collides with the object PV. Note that the “automatic braking start time threshold TBSth” is a time (a time length) from a time point at which an automatic braking (i.e., an automatic emergency brake “AEB”) that decelerates the host vehicle HV at a predetermined deceleration has to be started at the latest in order to fully stop the host vehicle HV before the host vehicle HV collides with the obstacle PV to a time point at which the host vehicle is fully stopped. In other words, the “automatic braking start time threshold TBSth” is equal to the predicted time to collision TTC at a time point at which the automatic braking has to be started at the latest. The automatic braking start time threshold TBSth has been obtained in advance and stored in the ROM of the vehicle control ECU 10.

Whereas, even when the predicted time to collision TTC becomes equal to or shorter than the automatic braking start time threshold TBSth, the present control apparatus DS does not start the automatic braking if the predicted time to collision TTC is longer than either one of the steering start time threshold TSRSth for a right turn and the steering start time threshold TSLSth for a left turn, whichever is shorter (refer to a case shown in FIG. 2A, where TBSth=Tb or Tc).

In this case, the present control apparatus DS starts the automatic braking, when the predicted time to collision TTC becomes equal to or shorter than either one of the steering start time threshold TSRSth for a right turn and the steering start time threshold TSLSth for a left turn, whichever is shorter.

This can avoid a situation where the automatic braking is started (i.e., the unnecessary automatic braking is executed/activated) when the driver has the intention to avoid the collision with the object by steering. However, in this case, the start of the automatic braking is delayed as compared to a time point at which predicted time to collision TTC becomes equal to or shorter than the automatic braking start time threshold TBSth, the deceleration amount (a change amount in the host vehicle speed) from the time point at which the automatic braking is started to the time point at which the host vehicle HV collides with the object PV is insufficient (deficient).

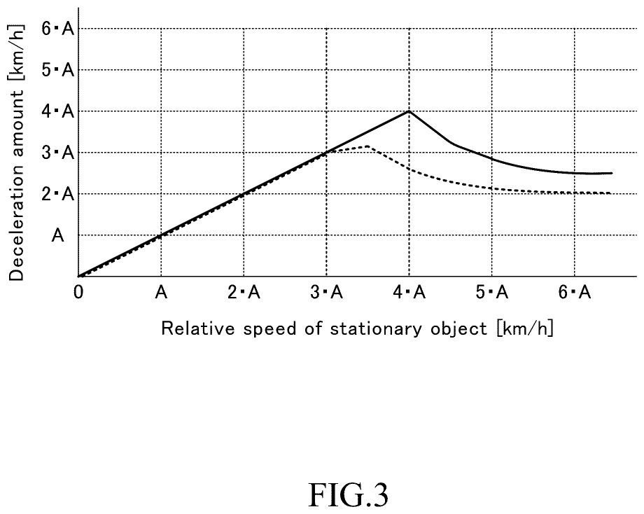

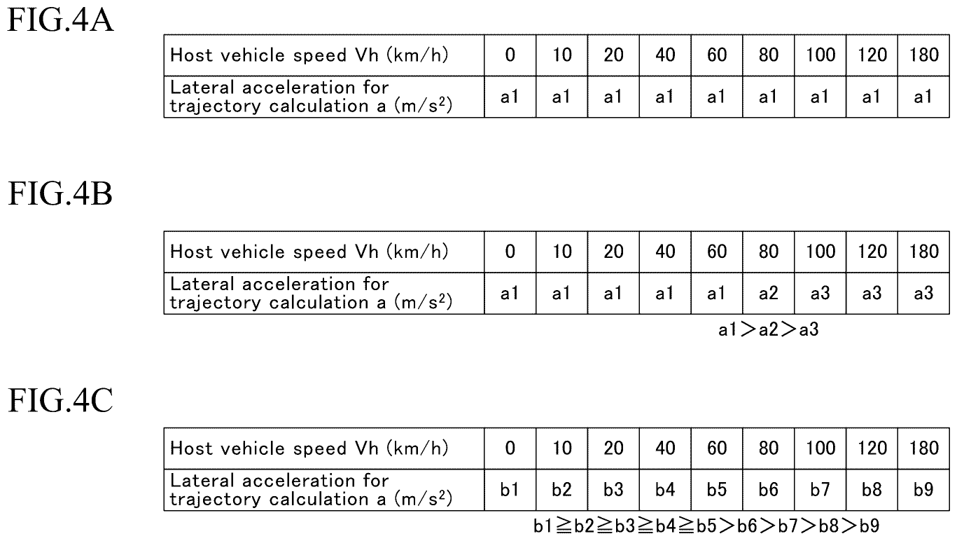

The broken line in FIG. 3 shows a relationship between the relative speed of a stationary object and the deceleration amount due to the automatic braking in a case where the above-described lateral acceleration for a trajectory calculation is maintained at a constant value a1 regardless of the host vehicle speed Vh, as shown in FIG. 4A. As shown in FIG. 3, it is understood that the deceleration amount due to the automatic braking is sufficient until the relative speed of the stationary object reaches 3·A (km/h), but is insufficient when the relative speed of the stationary object is over (greater than) 3·A (km/h).

In view of the above, the inventor of the present disclosure studied various data obtained when the driver tried to prevent the collision by steering. According to the study, the present inventor found that “the steering amount or the steering rate (speed)” for avoiding the collision tends to be small (i.e., the driver does not tend to steer relatively rapidly) when the host vehicle speed Vh is relatively high, as compared to a case where the host vehicle speed Vh is relatively low, and thus, the lateral acceleration of the host vehicle HV of when the driver tried to prevent the collision by steering when the host vehicle speed Vh is relatively high tends to be small as compared to the case where the host vehicle speed Vh is relatively low.

Based on the finding, as shown in FIG. 4B or FIG. 4C, the present control apparatus DS is configured to obtain the trajectory CL and the trajectory CR by adopting, as the lateral acceleration for a trajectory calculation, a value which is smaller when the host vehicle speed Vh is higher than a certain vehicle speed threshold (e.g., 60 (km/h) or 80 (km/h)) “than when the host vehicle speed Vh is lower than the certain vehicle speed threshold; and is configured to obtain, based on the thus obtained trajectory CL and the thus obtained trajectory CR, the steering start time threshold TSRSth for a right turn and the steering start time threshold TSLSth for a left turn. As a result, as shown in FIG. 2B, when the host vehicle speed Vh is higher than the vehicle speed threshold, “the steering start time threshold TSRSth for a right turn and the steering start time threshold TSLSth for a left turn” are relatively long.

Consequently, as shown by a solid line in FIG. 3, the deceleration amount due to the automatic braking is not insufficient until the host vehicle speed Vh (more accurately, the relative speed of the stationary object) reaches a greater value (in the example shown in FIG. 3, 4·A (km/h)). In other words, the present control apparatus DS can avoid the collision by the automatic braking even in a higher host vehicle speed range, without activating the unnecessary automatic braking.

### (Specific Operation)

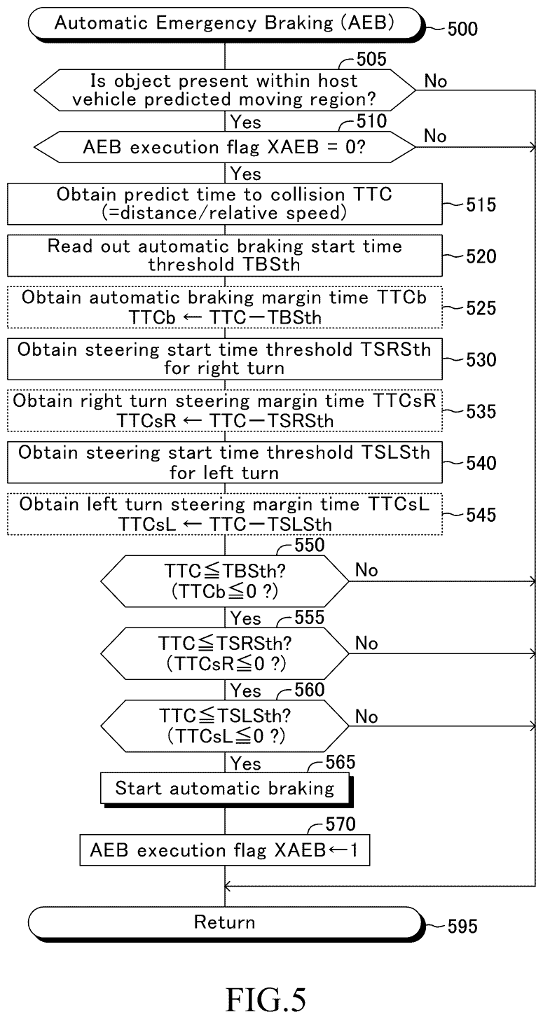

The CPU of the vehicle control ECU 10 (hereinafter, referred to as a “CPU”) executes a routine shown by a flowchart in FIG. 5, every time a predetermined time elapses. Hereinafter, “step” is expressed as “S”. When an appropriate time point comes, the CPU starts processing from S500 shown in FIG. 5, and proceeds to S505. At S505, the CPU determines whether or not an object (i.e., an obstacle) which is likely to collide with the host vehicle HV is present. More specifically, the CPU determines, based on the fusion object information, whether or not an object is present within the host vehicle predicted moving region PRA which is a moving area of the host vehicle in a case where the host vehicle HV travels for a predetermined time while maintaining the current moving direction and the current host vehicle speed Vh.

When the obstacle is present, the CPU proceeds to S510 from S505. At S505, the CPU determines whether or not a value of an AEB execution flag (i.e., an automatic emergency braking execution flag) XAEB is “0”. It should be noted that the value of the AEB execution flag XAEB is set to “0” through an initialization routine executed by the CPU when an unillustrated start switch (e.g., an ignition key switch) of the host vehicle HV is switched from an off position to an on position.

When the value of the AEB execution flag XAEB is “0”, the CPU executes processes from S515 to S545 described below, sequentially, and proceeds to step S550.

S515: The CPU calculates/obtains the predicted time to collision TTC by dividing the distance between the host vehicle and the obstacle by the relative speed of the obstacle.

S520: The CPU reads out the automatic braking start time threshold TBSth from the ROM.

S525: The CPU calculates/obtains an automatic braking margin time TTCb by subtracting the automatic braking start time threshold TBSth from the predicted time to collision TTC.

S530: The CPU obtains the lateral acceleration for a trajectory calculation by applying the host vehicle speed Vh to a look-up table shown in FIG. 4B, and calculates/obtains the steering start time threshold TSRSth for a right turn based on the lateral acceleration for a trajectory calculation, according to the above-described manner.

According to the look-up table shown in FIG. 4B, the lateral acceleration for a trajectory calculation is a constant value a1 when the vehicle speed Vh is equal to or lower than 60 km/h, the lateral acceleration for a trajectory calculation is a value a2 which is smaller than the value a1 when the vehicle speed Vh is equal to 80 km/h, and the lateral acceleration for a trajectory calculation is a value a3 which is smaller than the value a2 when the vehicle speed Vh is equal to or higher than 100 km/h. Note that, when the vehicle speed Vh is between a certain first vehicle speed and a certain second vehicle speed, the lateral acceleration for a trajectory calculation for that vehicle speed is obtained through a linear interpolation based on the “lateral acceleration for a trajectory calculation for the first vehicle speed” and the “lateral acceleration for a trajectory calculation for the second vehicle speed”. Therefore, according to the look-up table shown in FIG. 4B, the lateral acceleration for a trajectory calculation of when the host vehicle speed Vh is higher than 60 km/h, which is the certain speed, is (obtained to be) a value which is smaller than the lateral acceleration for a trajectory calculation of when the host vehicle speed Vh is lower than 60 km/h which is the certain speed.

S535: The CPU calculates/obtains a right turn steering margin time TTCsR by subtracting the steering start time threshold TSRSth for a right turn from the predicted time to collision TTC.

S540: The CPU obtains the lateral acceleration for a trajectory calculation by applying the host vehicle speed Vh to the look-up table shown in FIG. 4B, and calculates/obtains the steering start time threshold TSLSth for a left turn based on the lateral acceleration for a trajectory calculation, according to the above-described manner.

S545: The CPU calculates/obtains a left turn steering margin time TTCsL by subtracting the steering start time threshold TSLSth for a left turn from the predicted time to collision TTC.

At S550, the CPU determines whether or not the predicted time to collision TTC is equal to or shorter than the automatic braking start time threshold TBSth. In other words, the CPU determines whether or not the automatic braking margin time TTCb is equal to or smaller than “0”. When the predicted time to collision TTC is equal to or shorter than the automatic braking start time threshold TBSth, the CPU proceeds to S555.

At S555, the CPU determines whether or not the predicted time to collision TTC is equal to or shorter than the steering start time threshold TSRSth for a right turn. In other words, the CPU determines whether or not the right turn steering margin time TTCsR is equal to or smaller than “0”. When the predicted time to collision TTC is equal to or shorter than the steering start time threshold TSRSth for a right turn, the CPU proceeds to S560.

At S560, the CPU determines whether or not the predicted time to collision TTC is equal to or shorter than the steering start time threshold TSLSth for a left turn. In other words, the CPU determines whether or not the left turn steering margin time TTCsL is equal to or smaller than “0”. When the predicted time to collision TTC is equal to or shorter than the steering start time threshold TSLSth for a left turn, the CPU proceeds to S565.

At S565, the CPU starts the automatic braking to decelerate the host vehicle at the predetermined deceleration. As is apparent from the above, the automatic braking is started when the predicted time to collision TTC becomes equal to or smaller than a minimum threshold among “the automatic braking start time threshold TBSth, the steering start time threshold TSRSth for a right turn, and the steering start time threshold TSLSth for a left turn”. Subsequently, at S570, the CPU sets the value of the AEB execution flag XAEB to “1”. Thereafter, the CPU proceeds to S595 to terminate the present routine tentatively.

Note that, when the CPU makes a “No” determination at any of the steps of S505, S510, S550, S555, and S560, the CPU directly proceeds to S595 from the step at which the CPU makes a “No” determination, to terminate the present routine tentatively.

As has been described above, the present control apparatus obtains the steering start time threshold, using the “lateral acceleration for a trajectory calculation that is smaller when the host vehicle speed is higher than the certain speed than when the host vehicle speed is lower than the certain speed”. Therefore, the steering start time threshold of when the host vehicle speed is higher than the certain speed becomes longer, and thus, a range of the host vehicle speed in which the automatic braking is started when the predicted time to collision TTC becomes equal to or shorter than the automatic braking start time threshold expands to a higher speed. Consequently, the present control apparatus DS can shrink a speed range in which the deceleration amount due to the automatic braking is insufficient, while avoiding the unnecessary automatic braking, so as to reduce a frequency that the deceleration amount due to the automatic braking is insufficient.

Note that the CPU may use a look-up table shown in FIG. 4C, in place of the look-up table shown in FIG. 4B, to obtain the lateral acceleration for a trajectory calculation, and may obtain “the steering start time threshold TSLSth for a left turn and the steering start time threshold TSRSth for a right turn” based on (using) the thus obtained lateral acceleration for a trajectory calculation. A relationship among the lateral accelerations for a trajectory calculation (i.e., values b1 to b9) obtained based on the look-up table shown in FIG. 4C is shown by an inequality expression in FIG. 4C. Furthermore, the CPU may omit “S525, S535, and S545” shown in FIG. 5. In addition, the CPU may perform the following processes in place of the processes in the steps from S550 to S560.

Namely, the CPU is configured to:
select, as a determination time threshold, the minimum time threshold from among “the automatic braking start time threshold TBSth, the steering start time threshold TSRSth for a right turn, and the steering start time threshold TSLSth for a left turn”;
determine whether or not the predicted time to collision TTC is equal to or shorter than the selected determination time threshold; and
start the automatic braking when the predicted time to collision TTC becomes equal to or shorter than the selected determination time threshold.

### Modified Example

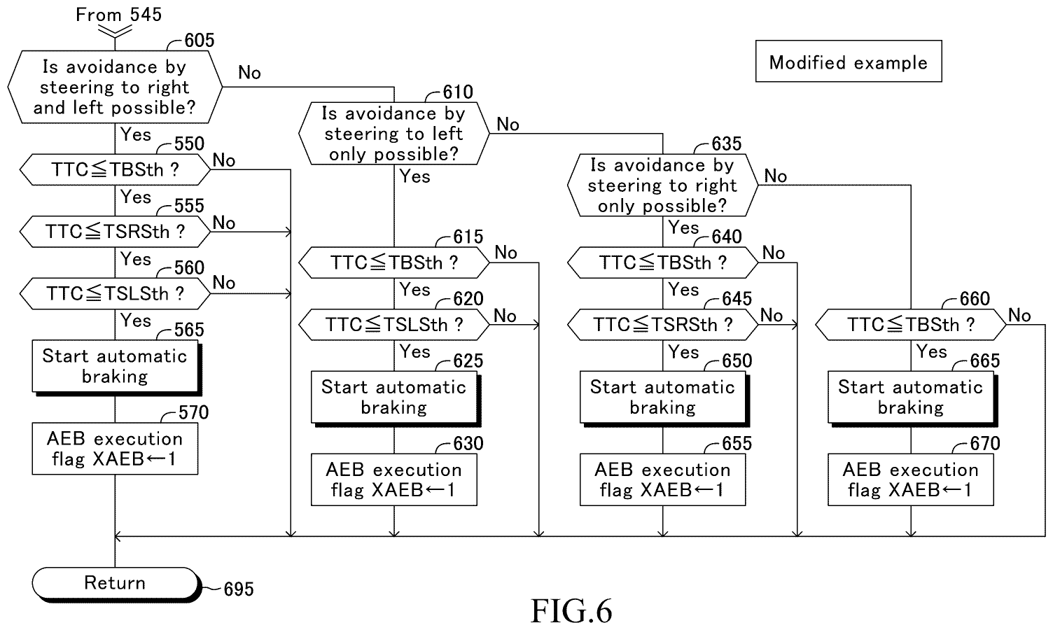

The CPU of the vehicle control ECU 10 of a modified example according to the present control apparatus DS executes a routine shown in FIG. 6, in which some of the steps shown in FIG. 5 are replaced with steps shown in FIG. 6.

The CPU proceeds to S605 shown in FIG. 6 after it executes the process of S545 shown in FIG. 5. At S605, the CPU determines, based on the fusion object information, the demarcation line information, the image data from the camera, and the like, whether or not there is a space into which the host vehicle HV can enter (i.e., a space through which the host vehicle HV can pass) in each of a left side area of the obstacle and a right side area of the obstacle. In other words, the CPU determines whether the CPU can turn the host vehicle HV to the left side to avoid the collision between the host vehicle HV and the obstacle without causing the host vehicle HV to collide with another object, and the CPU can turn the host vehicle HV to the right side to avoid the collision between the host vehicle HV and the obstacle without causing the host vehicle HV to collide with another object.

When the CPU makes a “Yes” determination at S605, the CPU executes processes from S550 to S570, that have been described with reference to FIG. 5, and proceeds to S695 to terminate the present routine tentatively. Note that, when the CPU makes a “No” determination at one of S550 to S560, the CPU directly proceeds to S695 from the step at which the CPU makes a “No” determination.

Whereas, when the CPU makes a “No” determination at S605, the CPU proceeds to S610. At S610, the CPU determines whether or not the CPU can turn the host vehicle HV (only) to the left side to avoid the collision between the host vehicle HV and the obstacle without causing the host vehicle HV to collide with another object.

When the CPU makes a “Yes” determination at S610, the CPU makes a determination which is the same as one made at S550, at S615.

When the CPU makes a “Yes” determination at S615, the CPU makes a determination which is the same as one made at S560, at S620.

When the CPU makes a “Yes” determination at S620, the CPU starts the automatic braking at S625, sets the value of the AEB execution flag XAEB to “1” at S630, and proceeds to S695.

Note that, when the CPU makes a “No” determination at one of S615 and S620, the CPU directly proceeds to S695 from the step at which the CPU makes a “No” determination.

Note that, when the CPU makes a “Yes” determination at S610, the CPU may select, as a time threshold, a smaller threshold among the automatic braking start time threshold TBSth and the steering start time threshold TSLSth for a left turn, and may execute the processes of S625 and S630 when the predicted time to collision TTC is equal to or smaller than the thus selected time threshold.

When the CPU makes a “No” determination at S610, the CPU proceeds to S635. At S635, the CPU determines whether or not the CPU can turn the host vehicle HV (only) to the right side to avoid the collision between the host vehicle HV and the obstacle without causing the host vehicle HV to collide with another object.

When the CPU makes a “Yes” determination at S635, the CPU makes a determination which is the same as one made at S550, at S640.

When the CPU makes a “Yes” determination at S640, the CPU makes a determination which is the same as one made at S555, at S645.

When the CPU makes a “Yes” determination at S645, the CPU starts the automatic braking at S650, sets the value of the AEB execution flag XAEB to “1” at S655, and proceeds to S695.

Note that, when the CPU makes a “No” determination at one of S640 and S645, the CPU directly proceeds to S695 from the step at which the CPU makes a “No” determination.

Note that, when the CPU makes a “Yes” determination at S635, the CPU may select, as a time threshold, a smaller threshold among the automatic braking start time threshold TBSth and the steering start time threshold TSRSth for a right turn, and may execute the processes of S650 and S655 when the predicted time to collision TTC is equal to or smaller than the thus selected time threshold.

When the CPU makes a “No” determination at S635, the CPU proceeds to S660. At S660, the CPU makes a determination which is the same as one made at S550. When the CPU makes a “Yes” determination at S660, the CPU starts the automatic braking at S665, sets the value of the AEB execution flag XAEB to “1” at S670, and proceeds to S695. When the CPU makes a “No” determination at S660, the CPU directly proceeds to S695.

As has been described, the modified example of the present control apparatus DS starts the automatic braking while taking into consideration steering the host vehicle toward the side area into which the host vehicle HV can enter. Consequently, the present control apparatus DS can shrink the speed range in which the deceleration amount due to the automatic braking is insufficient, while avoiding the unnecessary automatic braking, so as to reduce a frequency that the deceleration amount due to the automatic braking is insufficient.

It should be noted that the present disclosure is not limited to the above embodiment, and may adopt various modifications within the scope of the present disclosure. For example, the present disclosure can be applied to an autonomous driving vehicle, when the vehicle driving mode of that autonomous driving vehicle is changed from an autonomous driving mode to a mode where the driver manually drives that autonomous vehicle.

What is claimed is:

1. A vehicle control apparatus comprising a controller configured to:
obtain information on an object present around a host vehicle;
obtain, based on said information, a predicted time to collision which it takes for said host vehicle to collide with said object;
obtain, based on a predetermined lateral acceleration for a trajectory calculation, a steering start time threshold which is a time which it takes for said host vehicle to collide with said object at a time point at which a driver of said host vehicle has to start steering said host vehicle in order to avoid a collision between said host vehicle and said object; and
start an automatic braking, when said obtained predicted time to collision becomes equal to or shorter than either one of said steering start time threshold and an automatic braking start time threshold, whichever is shorter, said automatic braking start time threshold being a time which it takes for said host vehicle to collide with said object at a time point at which said automatic braking has to be started in order to avoid said collision between said host vehicle and said object,
wherein,
said controller is configured to obtain said steering start time threshold using, as said lateral acceleration for a trajectory calculation, a value which is smaller when a speed of said host vehicle is higher than a predetermined speed than when said speed of said host vehicle is lower than said predetermined speed.

2. The vehicle control apparatus according to claim 1,
wherein,
said controller is configured to:
obtain both of a steering start time threshold for a right turn which is said steering start time threshold when said host vehicle is assumed to steered rightward and a steering start time threshold for a left turn which is said steering start time threshold when said host vehicle is assumed to steered leftward; and
start said automatic braking, when said obtained predicted time to collision becomes equal to or shorter than a minimum time threshold among said steering start time threshold for a right turn, said steering start time threshold for a left turn, and said automatic braking start time threshold.

3. The vehicle control apparatus according to claim 1,
wherein,
said controller is configured to:
when there is a right space into which said host vehicle can enter when said host vehicle is steered rightward to avoid said collision and there is not a left space into which said host vehicle can enter when said host vehicle is steered leftward to avoid said collision,
obtain a steering start time threshold for a right turn which is said steering start time threshold when said host vehicle is assumed to steered rightward; and
start said automatic braking, when said obtained predicted time to collision becomes equal to or shorter than a time threshold among said steering start time threshold for a right turn and said automatic braking start time threshold, whichever is shorter.

4. The vehicle control apparatus according to claim 1,
wherein,
said controller is configured to:
when there is a left space into which said host vehicle can enter when said host vehicle is steered leftward to avoid said collision and there is not a right space into which said host vehicle can enter when said host vehicle is steered rightward to avoid said collision,
obtain a steering start time threshold for a left turn which is said steering start time threshold when said host vehicle is assumed to steered leftward; and
start said automatic braking, when said obtained predicted time to collision becomes equal to or shorter than a time threshold among said steering start time threshold for a left turn and said automatic braking start time threshold, whichever is shorter.

5. A vehicle control method comprising:
a step of obtaining information on an object present around a host vehicle;
a step of obtaining, based on said information, a predicted time to collision which it takes for said host vehicle to collide with said object;
a step of obtaining, based on a predetermined lateral acceleration for a trajectory calculation, a steering start time threshold which is a time which it takes for said host vehicle to collide with said object at a time point at which a driver of said host vehicle has to start steering said host vehicle in order to avoid a collision between said host vehicle and said object; and
a step of starting an automatic braking, when said obtained predicted time to collision becomes equal to or shorter than either one of said steering start time threshold and an automatic braking start time threshold, whichever is shorter, said automatic braking start time threshold being a time which it takes for said host vehicle to collide with said object at a time point at which said automatic braking has to be started in order to avoid said collision between said host vehicle and said object,
wherein,
said step of obtaining said steering start time threshold is a step of obtaining said steering start time threshold by setting said lateral acceleration for a trajectory calculation to a value which is smaller when a speed of said host vehicle is higher than a predetermined speed than when said speed of said host vehicle is lower than said predetermined speed.
